(19) United States
(12) Patent Application Publication
(10) Pub. No.: US 2008/0246613 A1
(43) Pub. Date: Oct. 9, 2008

(54) SYSTEM AND METHOD FOR WIRELESS SECURITY THEFT PREVENTION

(75) Inventors: William Linstrom, Petaluma, CA (US); Greg Wickham, Petaluma, CA (US); Brian Scott, Santa Rosa, CA (US)

Correspondence Address: PAUL, HASTINGS, JANOFSKY & WALKER LLP, 875 15th Street, NW, Washington, DC, 20005, US

(73) Assignee: WaveTrack Systems, Inc., Petaluma, CA (US)

(21) Appl. No.: 12/056,204

(22) Filed: Mar. 26, 2008

Related U.S. Application Data
(60) Provisional application No. 60/919,944, filed on Mar. 26, 2007.
(60) Provisional application No. 60/919,945, filed on Mar. 26, 2007.
(60) Provisional application No. 60/919,946, filed on Mar. 26, 2007.
(60) Provisional application No. 60/919,947, filed on Mar. 26, 2007.
(60) Provisional application No. 60/919,948, filed on Mar. 26, 2007.
(60) Provisional application No. 60/919,949, filed on Mar. 26, 2007.
(60) Provisional application No. 60/964,888, filed on Aug. 16, 2007.

(51) Int. Cl. G08B 13/14

(52) U.S. Cl. 340/572.4

(57) ABSTRACT

A merchandise security system in accordance with one embodiment comprising a security tag configured to be attached to an item; a receiver system configured to receive signals from the security tag and capable of generating location information for the security tag; and a security tag tracking system for receiving location information from the receiver system and determining potential security related problems. A merchandise security system in accordance with another embodiment comprising a security tag configured to be attached to an item; a receiver system configured to receive an alert signal from the security tag upon removal of the security tag from the item; and a security tag tracking system coupled to the receiver system for receiving alert information from the receiver system and determining a potential security related problem.

This application claims priority to U.S. Provisional Patent Application No. 60/919,944, filed Mar. 26, 2007, entitled INDOOR REAL-TIME TRACKING SYSTEM TO SELECT AND REMOTELY CONTROL THE PAN-TILT-ZOOM OF CLOSED CIRCUIT VIDEO CAMERAS FOR VIDEOGRAPHING TRACKED OBJECTS, which is incorporated herein by reference in its entirety.

This application also claims priority to U.S. Provisional Patent Application No. 60/919,945, filed Mar. 26, 2007, entitled AUTOMATED METHOD OF ALERTING AND DIRECTING SECURITY PERSONNEL TO THE LOCATION OF A POTENTIAL THEFT OR THEFT IN PROGRESS, which is incorporated herein by reference in its entirety.

This application also claims priority to U.S. Provisional Patent Application No. 60/919,946, filed Mar. 26, 2007, entitled DEVICE FOR REMOTE AUTOMATIC DETECTION AND ALERT OF REMOVAL OF SECURITY TAG, which is incorporated herein by reference in its entirety.

This application also claims priority to U.S. Provisional Patent Application No. 60/919,947, filed Mar. 26, 2007, entitled DEVICE FOR REAL-TIME INVENTORY LOCATION AND TRACKING, which is incorporated herein by reference in its entirety.

This application also claims priority to U.S. Provisional Patent Application No. 60/919,948, filed Mar. 26, 2007, entitled TECHNOLOGY TO PREVENT UNAUTHORIZED REMOVAL OF SECURITY TAG AT POINT OF SALE, which is incorporated herein by reference in its entirety.

This application also claims priority to U.S. Provisional Patent Application No. 60/919,949, filed Mar. 26, 2007, entitled METHOD OF SECURITY TAG ASSOCIATION WITH SPECIFIC ITEM, which is incorporated herein by reference in its entirety.

This application also claims priority to U.S. Provisional Patent Application No. 60/964,888, filed Aug. 16, 2007, entitled DEVICE FOR REMOTE AUTOMATIC DETECTION AND ALERT OF REMOVAL OF SECURITY TAG, which is incorporated herein by reference in its entirety.

### BACKGROUND

1. Field of the Invention

The present invention relates to merchandise security systems, more particularly the present invention relates to a merchandise security system that provides real-time tracking of merchandise.

2. Discussion of the Related Art

Employee or customer theft is a common problem for retailers. The current methods of preventing theft are expensive and unable to reliably prevent theft. Amongst the difficulties of preventing theft is the problem of being able to apprehend individuals who are attempting to remove stolen items from a retail store.

Stores typically employ loss prevention professionals who are responsible for all types of loss prevention including environmental, operational, accidental, and theft. Retail chains differ in their approach to deploying loss prevention personnel. Some chains deploy loss prevention personnel in virtually each store. Other firms have loss prevention personnel deployed over a region with many stores, sometimes in the range of 20-30 stores per person.

Theft prevention systems and security measures currently available today include, for example, perimeter security systems. Perimeter systems involve the use of security tags such as Radio Frequency Identification (RFID) and Electronic Article Surveillance (EAS) devices and are primarily focused on the prevention of shoplifting. Although such devices are effective for deterring common theft, perimeter systems fail to address key theft related issues such as opportunistic shoplifting techniques used by employees or organized thieves. Perimeter systems are not data aware and do not identify or discriminate between merchandise, nor do they integrate with enterprise class information systems. Furthermore, perimeter systems do not provide real time positioning information. They also have high instances of false-positives, which leads the staff no longer taking the alarms seriously.

Existing practices to address employee, insider and Organized Retail Crime (ORC) theft are labor intensive, time consuming and expensive. Identifying and catching employee thieves require loss prevention personnel to: (1) sift through cash register exception reporting data to spot trends of excessive refunding or ringing up “no sale” by individual employees; (2) receive tips from other employees on theft activity; and (3) run “sting operations” or set up special surveillance equipment.

With current technology and techniques, loss prevention success is limited and productivity is low. What is needed is a theft prevention system that addresses one or more of the needs above.

### SUMMARY

The embodiments describing herein include methods and system relating to a merchandise security system.

One embodiment includes a merchandise security system comprising a security tag configured to be attached to an item; a receiver system configured to receive signals from the security tag and capable of generating location information for the security tag; and a security tag tracking system coupled to the receiver system for receiving location information from the receiver system and determining a potential security related problem.

Another embodiment includes a merchandise security system comprising a security tag configured to be attached to an item; a receiver system configured to receive an alert signal from the security tag upon removal of the security tag from the item; and a security tag tracking system coupled to the receiver system for receiving alert information from the receiver system and determining a potential security related problem.

Yet another embodiment includes a security tag for aiding in the detection of theft, the device comprising circuitry; a battery; and an antenna, wherein said circuitry and said antenna are powered by said battery, and wherein said circuitry comprises an instruction set to cause said antenna to transmit a signal when said security tag is attached to an article and later removed from said article.

### BRIEF DESCRIPTION OF THE DRAWINGS

The above and other aspects, features and advantages of the present invention will be more apparent from the following more particular description thereof, presented in conjunction with the following drawings, wherein:

FIG. 1 illustrates a system diagram of a merchandise security system in accordance with one embodiment;

FIG. 2 is a screen shot illustrating an exemplary graphical user interface for a merchandise security system in accordance with one embodiment;

FIG. 3 is a flow diagram illustrating a method for associating a security tag with a specific item in accordance with one embodiment;

FIG. 4 is a flow diagram illustrating a process for real-time inventory location and tracking in accordance with one embodiment;

FIG. 5 is a flow diagram illustrating a method of alerting loss prevention personnel if there is a security related issue in accordance with one embodiment;

FIG. 6 is a flow diagram illustrating a method of alerting loss prevention personnel if there is an unauthorized removal of a security tag at a point-of-sale terminal in accordance with one embodiment;

FIG. 7 is a flow diagram illustrating a method of alerting loss prevention personnel if there is an unauthorized removal of a security tag in accordance with one embodiment;

FIG. 8 is a flow diagram illustrating a method of selecting and remotely controlling video cameras for real-time tracking of an item in accordance with one embodiment;

FIG. 9 is a flow diagram illustrating a method of generating a control signal for a video camera for real-time tracking of an item in accordance with one embodiment;

FIG. 10 is a block diagram of a security tag in accordance with one embodiment;

FIG. 11 is a flow diagram illustrating a method of detecting a theft at a point-of-sale terminal in accordance with one embodiment;

FIG. 12 is a flow diagram illustrating a method of detecting a zone violation in accordance with one embodiment;

FIG. 13 is a flow diagram illustrating a method of detecting tag disappearance in accordance with one embodiment;

FIG. 14 is a flow diagram illustrating a method of detecting rapid movement of a tag in accordance with one embodiment;

FIG. 15 is a flow diagram illustrating a method of detecting an inventory location timeout violation in accordance with one embodiment;

FIG. 16 is a flow diagram illustrating a method of detecting restricted location timeout violation in accordance with one embodiment;

FIG. 17 is a flow diagram illustrating a method of detecting a zone transition violation in accordance with one embodiment;

FIG. 18 is a flow diagram illustrating a method of detecting an item that has not been retagged in accordance with one embodiment;

FIG. 19 is a flow diagram illustrating a method of detecting possible organized crime activity in accordance with one embodiment;

FIG. 20 is a flow diagram illustrating a method of displaying video from cameras with the best view of a security tag, regardless of where they are in a store in accordance with one embodiment; and

FIG. 21 is a flow diagram illustrating a method of concatenating video from multiple cameras to present a video history of the activities associated with a security tag in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE DRAWINGS

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

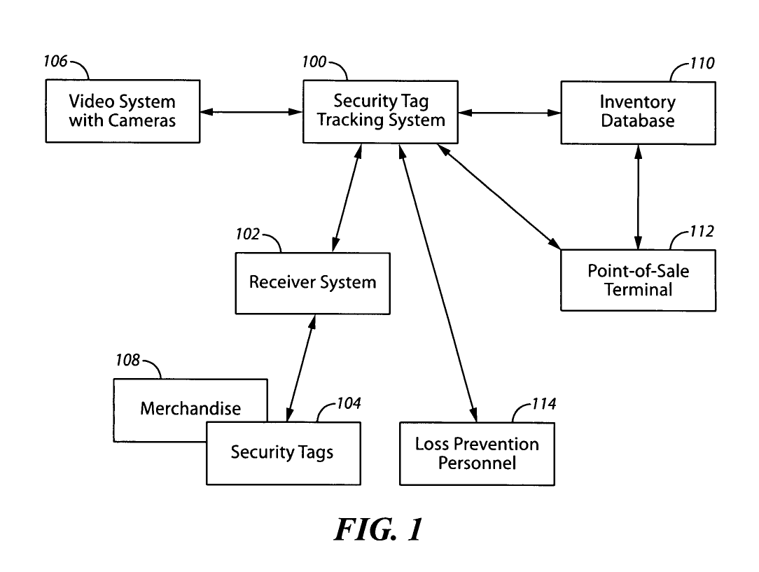

Referring to FIG. 1, a system diagram is shown of a merchandise security system in accordance with one embodiment. Shown is a plurality of security tags 104 (also referred to herein as the security tags 104), merchandise 108, a receiver system 102, a security tag tracking system 100, a video camera system 106, loss prevention personnel 114, a point-of-sale terminal system 112, and an inventory database 110.

Security tags 104 are affixed to the merchandise 108. Generally, a single product will be associated with a single security tag 104. For example, an MP3 player, a digital camera, a jacket, or a pair of pants would have a security tag affixed to the packaging of the product or the product itself. The security tags 104 are in communication with the receiver system 102. The receiver system 102 is coupled with the security tag tracking system 100. In some embodiments, the security tag tracking system 100 is coupled with the inventory database 110, the point-of-sale terminal system 112, the video camera system 106, and/or the loss prevention personnel 114.

As described above, the security tags 104 are physically affixed to the merchandise 108. In some embodiments when the security tags 104 are removed from the merchandise, the security tags indicate tag removal to the receiver system 102 by sending an alert signal. The alert signal is then forwarded to the security tag tracking system 100 which will implement a group of rules to determine if a potential security problem exists. In some instances the removal of a security tag causes no concern and in other instances it will cause the activation of an alarm. Some of these various situations will be described below in this application.

The security tags 104 are coupled to the receiver system 102 through a wireless communication link. Information is sent from the security tags 104 to the receiver system 102 that allows the receiver system 102 to identify the location of each security tag 104. In one embodiment an identification number is broadcast from the security tag. Alternatively, an ultra wide band (UWB) pulse is transmitted from each tag at a specified frequency that individually identifies a specific tag. UWB technology is advantageous for a number of reasons. For example one unique aspect of UWB is the accuracy of localization possible in a UWB system—namely in some instances as good as +/−15 cm. There are other commercial systems utilizing WiFi (802.11) systems for localization which provide location accuracy of 7-21 feet depending on local conditions. Active Radio Frequency Identification (ARFID) can be used for localization which provides an accuracy of +/−25 feet. The current state of the art tracking capabilities in the WiFi and ARFID systems are too imprecise to use in an effective retail security system such as the one described herein. Therefore, while the current preferred technology for the security tags is a UWB system, any tracking system which can support location accuracy that is feasible for a retail security system can be used in accordance with the embodiments described herein.

An overview of ultra wide band location tracking technology can be found at the following references, all of which are incorporated herein by reference in their entirety:
(1) “Location Accuracy of an UWB Localization System Based on CMOS-based Chip Set,” by Michael Tücher et al., March 2005, available at:
<www.fhnw.ch/technik/ime/publikationen/de/publikationen/2005/pub_extendedabstract.pdf>,
(2) “Accuracy of a Commercial UWB 3D Location/Tracking System and its Impact on LT Application Scenarios,” by Volker Schwarz et al., 2005, available at:
<www.fhnw.ch/technik/ime/publikationen/de/publikationen/2005/pub_icu2005_final_sv.pdf>, and
(3) “UWB: Technology and Implications for Sensor Networks,” by Robert Szewczyk, Aug. 27, 2004, available at:
<www.cs.berkeley.edu/˜binetude/NEST/UWB.ppt>.

Furthermore, there are at least three commercial companies supplying UWB Real Time Location System (RTLS) tags and receivers (i.e., Ubisense Inc., Time Domain Inc., and Multi-Spectral Inc.). The specific technology used for the security tag 104 may vary depending upon future technologies.

The receiver system 102, in one embodiment, is a group of sensors that receives the information that is transmitted from the security tags 104 and generates location based information for use by the security tag tracking system 100. In one embodiment, the receiver system 102 generates location information in an (x, y, z) or an (x, y, z, t) format, where x, y, and z are location coordinates and t is time. The receiver system 102 uses, for example, triangulation techniques and the time delay difference between when different sensors receive the transmitted signal from the security tag 104 in order to generate the location information of the security tag 104. The UWB system can use both the azimuth and elevation Angle of Arrival (AOA) of the UWB signal and the Time Difference of Arrival (TDOA) to determine the location of the security tag 104. Not all UWB system suppliers use the same methods of triangulation. Some use the three methods mentioned above and thus can utilize fewer sensors to determine three dimensions of location. Others use only TDOA and thus require a greater number of sensors to determine three dimensions of location. The embodiments described herein can use any embodiment of UWB Real Time Location System (RTLS) and are not limited to any particular implementation methodology.

Alternative formats can be used for the location information, such as, for example, a polar coordinate system (e.g., (r, θ, z), (r, θ, z, t), (r, θ) or (r, θ, t)) can alternatively be utilized in the security tag tracking system. Alternatively, in a simplified version of the system an (x, y) or (x, y, t) format can be utilized.

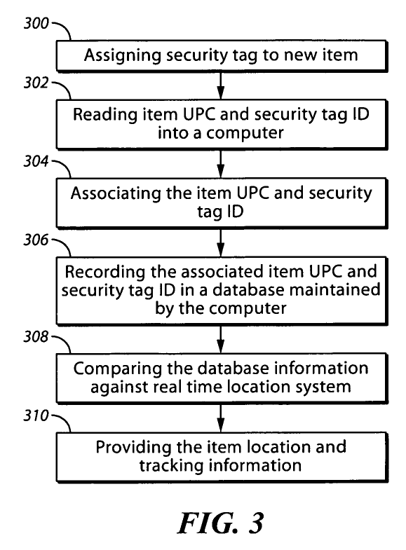

The receiver system 102 is coupled to the security tag tracking system 100 through either a wired or wireless communication link and the location information of the security tags 104 is provided from the receiver system 102 to the security tag tracking system 100. The security tag tracking system 100 processes the location information from the security tags 104 and determines the geographic location of the security tags 104. For example, the security tag tracking system 100 will determine the location of the security tags 104 within the store. In some embodiments, the security tag tracking system 100 processes the information from the receiver system 102 and determines if there is a potential security related problem. Examples of the various types of potential security related problems are discussed below with reference to FIGS. 3-9 and 11-21.

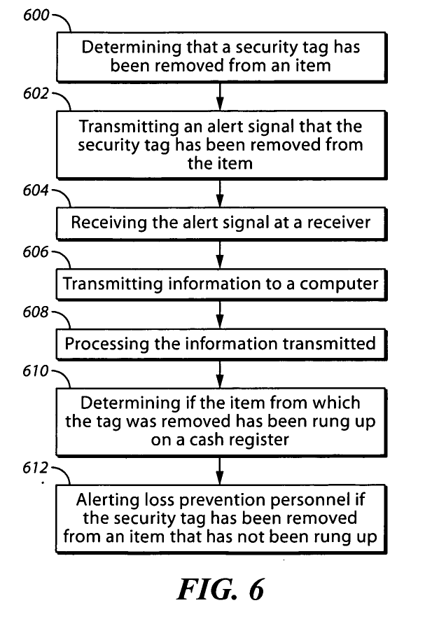

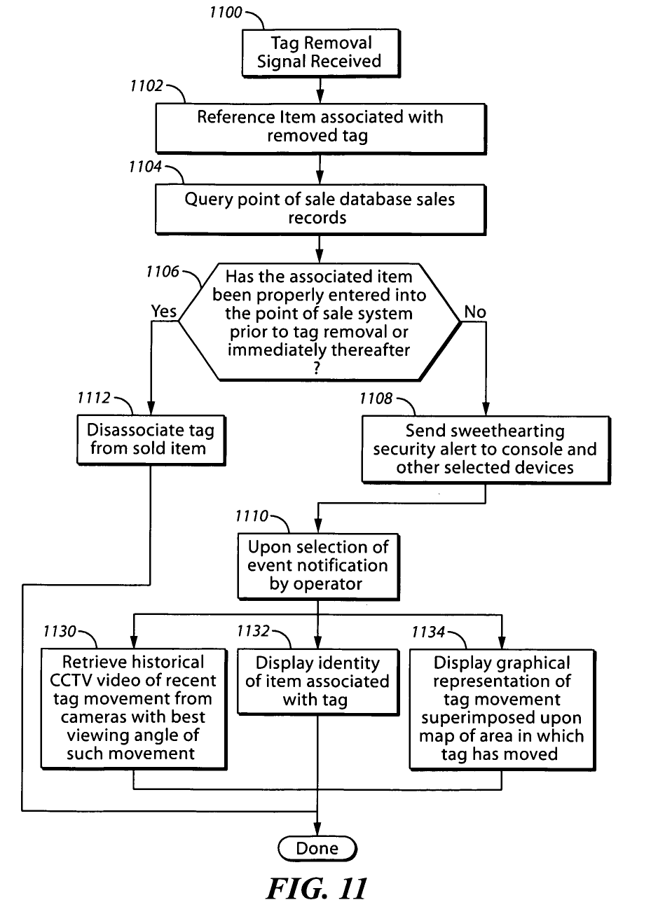

In some embodiments, the security tag tracking system 100 is coupled to the point-of-sale terminal 112 and/or inventory database 110 through a wired or wireless communication link. The security tag tracking system 100 compares the information received from the security tags 104 against the information received from the point-of-sale terminal 112 and/or the inventory database 110 to determine if there is a potential security related problem. For example, if a security tag 104 is removed from an item of merchandise, the security tag tracking system will determine if the item of merchandise that is associated with the removed security tag 104 has been “rung up” at the point of sale terminal. That is, the security tag tracking system will determine if the item of merchandise has been properly entered into the point of sale terminal 112 prior to the tag removal or at some predetermined period of time thereafter. If the item of merchandise has not been “rung up” within the predetermined time frame the system will generate an alarm. This process is further described below with reference to FIGS. 6 and 11.

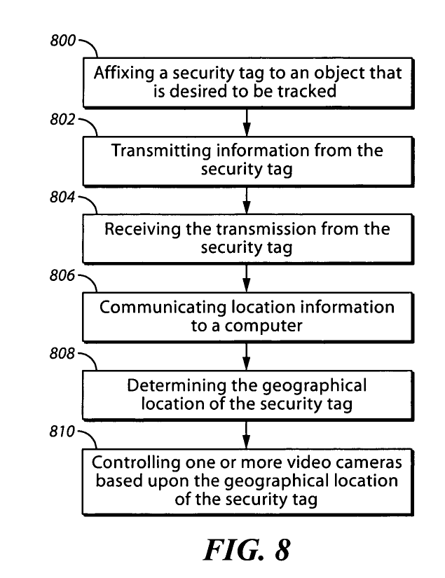

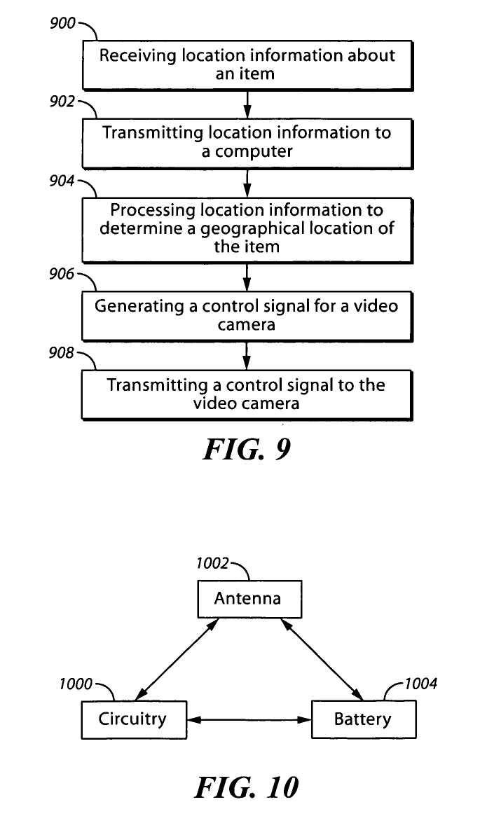

In some embodiments, the security tag tracking system 100 is coupled to a video camera system 106 through a wired or wireless communication link. The security tag tracking system 100 can instruct the video camera system 106 where one or more of the cameras should focus based upon detection of a potential security problem. Additionally, the location of one or more of the security tags 104 can help determine where the cameras should focus. As a security tag 104 keeps moving, the security tag tracking system 100 can send further commands to the video camera system 106 such that the video system will keep recording the movement of the security tag. In many instances this will allow the video camera system 106 images of the person or people who are attempting to steal merchandise from the store. Further aspects of how the security tag tracking system 100 utilizes and controls the video camera system 106 are described herein with reference to FIGS. 8 and 9.

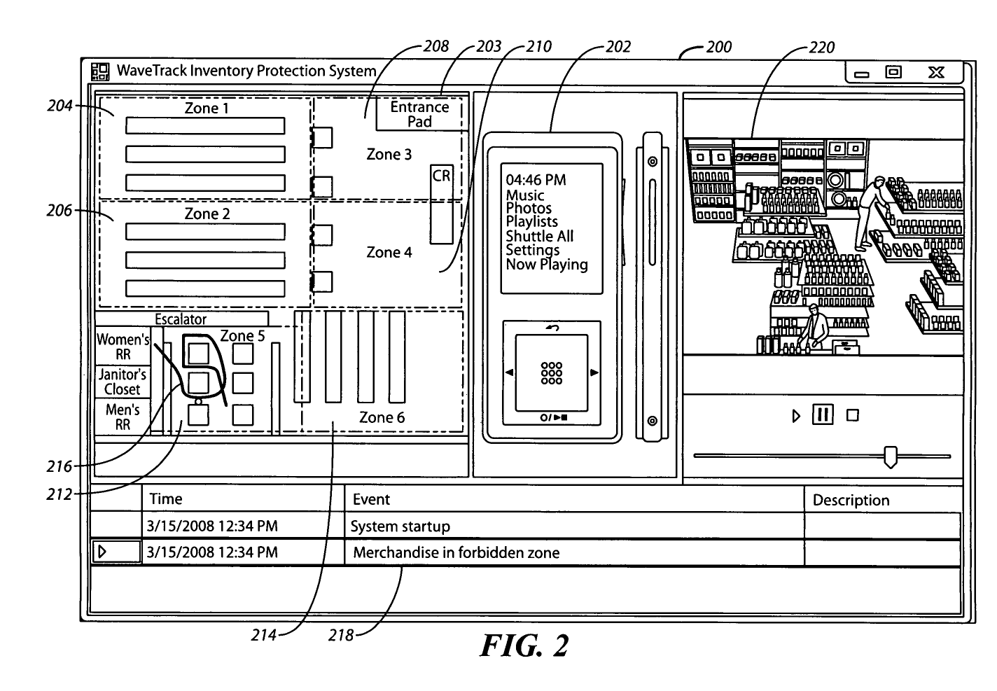

In some embodiments, the security tag tracking system 100 is coupled to loss prevention personnel (also referred to herein as security personnel) 114 through a wireless communication and can select which loss prevention personnel 114 to send information regarding potential security problems. For example, security personnel can be informed of potential security problems by the security tag tracking system 100 sending a message to a portable electronic device (e.g., a cell phone, pager, personal digital assistant, or smart phone). Additionally, as will be discussed below with reference to FIG. 2, loss prevention personnel 114 can be notified of potential security problems through a graphical user interface of the security tag tracking system 100. Either of these systems allows potential security problems to be communicated to loss prevention personnel 114 in an efficient manner.

The above description of FIG. 1 is meant to provide an overview of some of the capabilities of the security tag tracking system described herein. The following figures will provide further description of some of the capabilities and methods that can be implemented by the system.

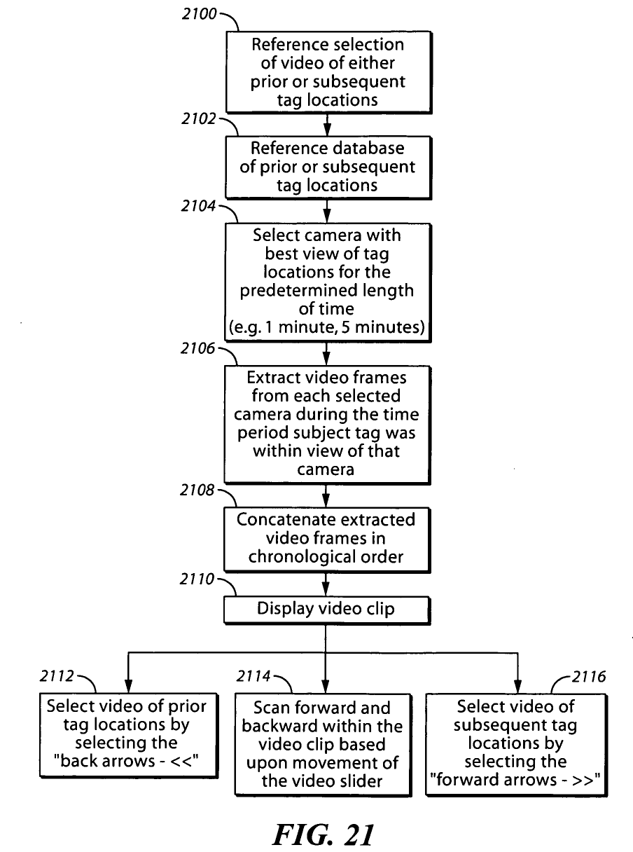

Referring to FIG. 2, shown is a screen shot illustrating an exemplary graphical user interface for a merchandise security system 200 in accordance with one embodiment. Shown is an item of merchandise 202, a representative graphical map 203, a system alert log 218, and a video image 220. The video image 220 display will vary depending upon events and selections made by an operator. If a security event is occurring the video image may display real time video of the event in progress. The video will be simultaneously displayed and record by a hard disk digital video recorder (DVR) or other recording method. If the security event is no longer in progress the video image will display historical footage, retrieved according to the method discussed below with reference to FIG. 21. Additionally, a slider interface (or other software interface) beneath the video image allows the security personnel or other operator to scroll backwards and forwards through recorded video footage. The representative graphical map 203 includes a first security zone 204, a second security zone 206, a third security zone 208, a fourth security zone 210, a fifth security zone 212, a sixth security zone 214, and other features correlating to areas within the store. The graphical user interface (GUI) is only one example of a GUI that can be used in accordance with the current system and many variations are possible that have additional or fewer features of the GUI described herein.

The graphical user interface provides information to security personnel in order, for example, to prevent theft from the store or detect other potential security problems.

The graphical map 203 is representative of a store where merchandise can be purchased. The store can be a traditional store, such as a convenience store, a department store, an outlet store or name brand store. Alternatively, the map can represent a company warehouse, outdoor area that needs monitoring or any other location where items (such as merchandise or goods) need to monitored or tracked. For example, a company could use the security tag tracking system to keep track of items that are owned by the company. In addition, tracking of store personnel is possible.

In the embodiment shown, the representative graphical map 203 represents a traditional department store that is selling, for example, clothing, electronics or house ware. The representative graphical map 203, as shown, is displaying the location of the item of merchandise 202 that is currently of interest to the security system 200. The software based merchandise security system 200 tracks the movement of a specific item 202 and displays the security tag tracking path 216 on the representative graphical map 203.

In the representative example, the fifth security zone 212 shows a security tag tracking path 216 for the item of merchandise 202. The security tag tracking path 216 shows that the item of merchandise 202 has traveled around the fifth security zone 216 and is heading into the women's restroom. At this point, the system will generate an alarm indicating that the item of merchandise 202 has entered into a forbidden zone. As shown the system alert log 218 has been updated to indicate such an alarm. At this point, the security tag tracking system will send a control signal to the video camera system in order to update the video image 220. The system will cause the video image 220 to focus on the outside of the women's restroom in order to obtain video of people coming out of the women's restroom. Additionally, if available, the system may acquire and display video from the outside of the women's restroom at the time the security tag entered into the forbidden zone. This will allow the store to obtain video of the person who entered into the women's restroom at the same time as the security tag. That is, the system can also retrieve the historical video that is available from the video camera system (e.g., a closed circuit television (CCTV) system) which had the best viewing angle of the location of the tag that is associated with triggering the security alert (e.g., the security tag entering the restricted zone). Security personnel will be notified and the person attempting to steal the merchandise can be apprehended or further monitored to determine if they mistakenly entered the restroom or if they are actually stealing the item. The security personnel are notified, for example, via a wireless communication device (e.g., a cell phone or personal digital assistant), such as will be further discussed below with reference to FIG. 5.

Referring to FIG. 3, a flow diagram is shown illustrating a method for associating a security tag with a specific item in accordance with one embodiment. This process is used to keep track of items that are associated with a specific security tag, such as an UWB tag. The security tags are each individually identified in the system. For example, each security tag can be identified in the system through a optical bar code, radio frequency identification (RFID) number, or the specific signal that the security tag transmits when operating in the system.

In step 300, a new item is assigned a security tag for tracking purposes. In step 302, the items Universal Product Code (UPC) or other identifying information is read into a computer. In step 304, the computer associates the identifying information of the item with the identifying information of the security tag. The computer is, for example, a computer or computers that are used to implement the security tag tracking system described herein. As described in this application, the security tag tracking system can be implemented by one or more computers without varying from the scope of the embodiments contemplated herein. The specific implementation and division of tasks, as described herein are logically separated but the implementation of hardware used to fulfill various tasks will vary from system to system.

Next, in step 306, the identifying information of the item with the identifying information of the security tag (referred to herein as the association information) is recorded in a database maintained by the computer. This allows the security tag tracking system to identify a specific security tag with a specific item of merchandise by referencing the database.

In step 308, the security tag tracking system compares the association information in the database against the real time tracking location system information in order to provide item location and tracking information to security personal, in step 310. As described herein, the location and tracking information can be provided to a mobile electronic device or can be provided to security personal through a graphical user interface such as shown above with reference to FIG. 2.

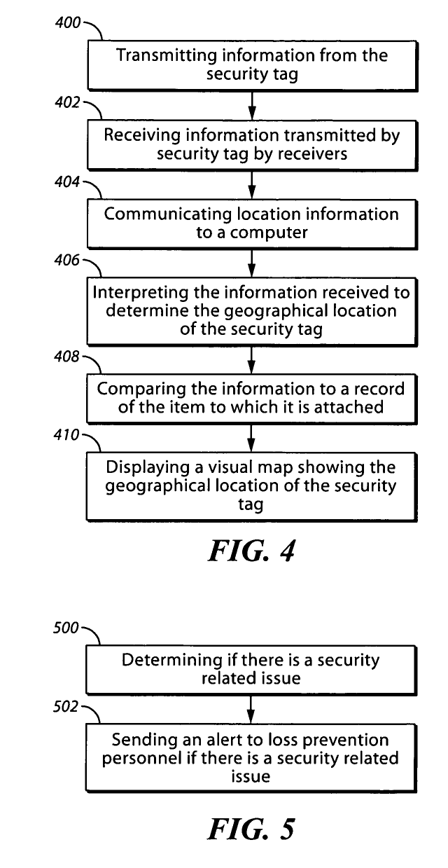

Referring next to FIG. 4, a flow diagram is shown illustrating a process for real-time inventory location and tracking in accordance with one embodiment. As described above, the security tag tracking system allows for displaying of location information in real-time for any number of items of merchandise that have been associated with a security tag. The location information can be used for loss prevention.

In step 400, the security tag wirelessly transmits information. This information includes, for example, security tag identification information. The security tag can transmit information in a variety of different ways such that the receivers can individually identify each security sensor in the system. For example, each security tag can transmit a pulse at a different frequency or different time slot. Alternatively, each security tag can transmit a digital identification number. Still alternatively, the security tags can only send information in response to a request from the receivers. Various other mechanisms can be used so that the receivers can individually identify each of the security tags within the system, all of which will not be described herein.

Next, in step 402, one or more receivers receive the information transmitted by the security tags. The one or more receivers will be referred to as the receiver system. As described above with reference to FIG. 1, the receivers can use a variety of techniques to determine the specific location of a tag, including using the time delay difference between when various sensors receive the information from the security tag to generate location information of the security tag. The location information identifies a specific location of the security tag within the store.

In step 404, the receiver system communicates the location information in one of a variety of formats or coordinate systems to a computer system through wired or wireless communication. The computer is used to implement the security tag tracking system described herein. Next, in step 406, the computer interprets the location information received to determine the geographical location of the security tag. In step 408, the location information from the security tag is compared against the database information to determine the specific item of merchandise that is associated with the security tag, and thus determine the specific location of the item of merchandise. In step 410, the location of the item of merchandise is displayed on a visual map. Optionally, associated information about the item of merchandise is also displayed by the security tag tracking system. For example, a picture of the item or name of the item can be displayed along side the map, such as was shown in FIG. 2.

Referring to FIG. 5, a flow diagram is shown illustrating a method of alerting loss prevention personnel if there is a security related issue in accordance with one embodiment. As described above, employee or customer theft is a common problem for retailers and prevention methods are inadequate. One of the major deficiencies in current systems is the ability to timely notify security personnel of a potential security problem and subsequently direct the security personnel to the location of the potential security problem.

In step 500, the security tag tracking system determines if there is a security related issue by implementing any number of various rules. For example, the security tag tracking system will interpret, among other things, data from the security tags, the item information, location of the security tag, information from the point-of-sale terminals, and/or inventory databases. Some examples of these rules will be described below with reference to FIGS. 6-9 and 11-21.

If the software system determines that there is a security related issue, in step 502, an alert is sent to loss prevention personnel. In one example, the alert is sent to the loss prevention personnel using a wireless device (e.g., a cell phone or personal digital assistant). The loss prevention personnel can use the information in order to attempt to prevent the loss of merchandise. The loss prevention personnel can be continually updated with information relevant to the security related issue as the security tag tracking system continues to monitor the tags. The information transmitted can include real time tracking information of the product and real time video footage of the product and historical information of recent product movement and historical video footage of recent product movement.

In one example, a potential security problem may have been initially identified in the back of a store. However, the location of the security tag for which the potential security problem is associated has since moved to the front of the store. In this example, the loss prevention personnel would have initially received an alert directing them to the back of the store, and would receive continued real time information redirecting them to the front of the store or other location of the security tag associated with the potential security problem. The various types of alerts and information transmitted to the loss prevention personnel will vary greatly depending upon the specific system implemented.

Referring to FIG. 6, a flow diagram is shown illustrating a method of alerting loss prevention personnel if there is an unauthorized removal of a security tag at a point-of-sale terminal in accordance with one embodiment. This can prevent multiple methods of theft. For example, one of the most prevalent types of theft unfortunately comes from employees of the store, such as a cashier working with an accomplice. The accomplice will enter the store and pick out a number of items—typically including an inexpensive item and an expensive item. The accomplice will bring the items to the cashier who will ring up only the inexpensive item. The cashier will then remove the security tag from the expensive item, and place the expensive item in a bag while placing the inexpensive item in a return or restock bin underneath the counter, and allow the accomplice to leave the store after only paying for the inexpensive item. This is a common scam and a significant source of inventory loss. This scam is in part successful because at the door the security personnel at retail stores often compare the number of items on a receipt with the number of items in a shopping bag without reading the receipt detail. Generally, if the number of items in the bag matches the number of items on the receipt the customer or thief will be allowed to exit.

Another example is price tag switching. A customer will enter a store and remove a price tag from an expensive item and replace it with a price tag removed from a less expensive item. The expensive item is then brought to the register and rung up for the less expensive price. The cashier is typically unaware of the price difference. The following method detects and prevents these types of theft.

In step 600, the security tag determines that it has been removed from the item that it was attached to. Various techniques for determining when a security tag has been removed are known. Some of the techniques are described below with reference to FIG. 10. In step 602, the security tag wirelessly transmits an alert that it has been removed from the item.

Next, in step 604, the receiver system receives the information transmitted by the security tags. In step 606, the receiver system transmits the information relating to a tag removal to a computer system such as the security tag tracking system. In step 608, the computer system processes the information from the receiver system. In step 610, the computer system queries the inventory database and/or the point-of-sale terminal to determine if the item which has had its security tag removed was rung up. The computer system can determine if the item was rung up at a point-of-sale terminal by comparing the information received from the security tags against the information received from the point-of-sale terminal and/or the inventory database to determine if there is a potential security related problem. For example, the security tag tracking system will determine if the item of merchandise has been properly entered into the point of sale terminal prior to the tag removal or at some predetermined period of time thereafter. If the price tag has been switched or if the wrong item has been entered into the point of sale terminal, the discrepancy will be detected by the system because the item associated with the removed tag was not entered into the point of sale system within the allowed timeframe from the time of tag removal.

In step 612, if the computer system determines that there is a security related issue due to a security tag being improperly removed, the system communicates an alert to loss prevention personnel.

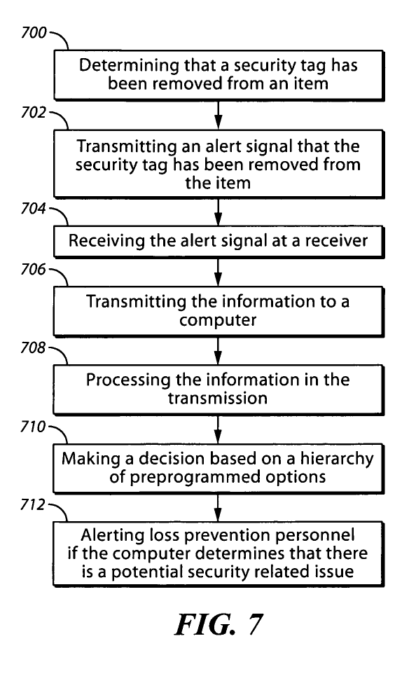

Referring to FIG. 7, a flow diagram is shown illustrating a method of alerting loss prevention personnel if there is an unauthorized removal of a security tag in accordance with one embodiment.

In step 700, the security tag determines that it has been removed from the item that it was attached to. Various techniques for determining when a security tag has been removed are known. Some of the techniques are described below with reference to FIG. 10. In step 702, the security tag wirelessly transmits an alert that it has been removed from the item.

Next, in step 704, the receiver system receives the information transmitted by the security tags. In step 706, the receiver system transmits the information relating to a tag removal to a computer system such as the security tag tracking system. In step 708, the computer system processes the information from the receiver system. In step 710, the computer system, based upon a set of rules, determines if there is a potential security related issue based upon the removal of the security tag from the item of merchandise. One example of this determination was described above with reference to FIG. 6 where the computer system determined that the item was not properly rung up at the point-of-sale terminal. Another example is if the removal of the security tag takes place within a certain location in the store where store employees would not usually remove security tags. This may indicate that the security tag is being removed by a thief. Other rules for determining if a security tag is improperly removed will be implemented depending upon the specific system implemented.

In step 712, if the computer system determines that there is a security related issue due to a security tag being improperly removed, the system communicates an alert to loss prevention personnel.

Referring to FIG. 8, a flow diagram is shown illustrating a method of selecting and remotely controlling video cameras for real-time tracking of an item in accordance with one embodiment.

It is common for retail stores to employ a security video camera system to monitor possible security violations. This type of video camera system is typically referred to as closed circuit television (CCTV). A CCTV usually incorporates one or more cameras strategically placed to capture either as much of the retail store as possible or the areas of strategic interest for detecting and preventing theft or other security violations. CCTV cameras may be fixed in their viewing angle and field of vision or may be equipped with pan, tilt, and zoom features that can remotely be controlled to cover a wide area and depth. The CCTV cameras are often linked to a recording device such as a hard disk Digital Video Recorder (DVR) or a video tape recorder. Hard disk DVR is the current state of the art and most common method or recording and archiving security camera footage. The specific method of recording the video can vary in the embodiments described herein. Generally, footage from each camera is recorded and archived for a predetermined period of time. If a security violation occurs, security personnel may review the archived video footage to find a video recording of the security violation. A video recording of a security violation is useful in many ways including as forensic evidence in a criminal prosecution or determining the identity of a perpetrator. Finding the appropriate footage in current CCTV and DVR methods often requires the security personnel to manually review footage from multiple camera recordings, a process which can be lengthy and time consuming.

In one embodiment, the security tag tracking system incorporates or works in conjunction with a CCTV system and DVR or other form of video database. The security tag tracking system causes video clips relevant to a security incident or potential security incident to be automatically retrieved from the archived footage from one or more security cameras and concatenated in the sequence of which they occurred. The security tag tracking system also allows a single video display to follow a security tag as it moves through the field of vision of multiple cameras, the display switching to the most appropriate camera feed to view the moving tag in real time as the tag moves from the field of vision of one camera to another. That is, the security tag tracking system can automatically control one or more of the video cameras to track one or more security tags and keep track of the video footage for playback.

The security tag tracking system, in accordance with some embodiments, is connected to the video camera system and can provide instructions for controlling the video camera system based upon events of note to the security tag tracking system. Therefore, the security tag tracking system and the video camera system interface in order to provide video surveillance of the location at which a tag is located or other location of interest depending upon events that are being processed by the security tag tracking system. When sending control information to the video camera system, the present security tag tracking system can optionally control the pan, tilt and zoom of various video cameras in order to capture video of areas of interest within the store.

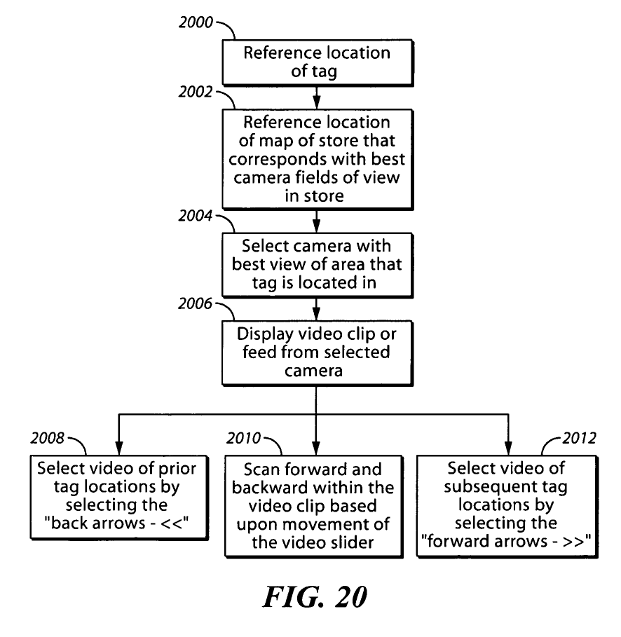

Two methods illustrating the security tag tracking system utilizing the video camera system to capture video footage of an event are described below with reference to FIGS. 20 and 21.

In operation, in step 800, a security tag is affixed to an object that is desired to be tracked. The object can be an item of merchandise or other item within the store. In step 802, the security tag transmits information that will be used to determine the location of the security tag. In step 804, the receiver system receives the information from the security tags and in step 806, the receiver system communicates location information to a computer system. In step 808, the computer system determines the geographical location of the security tag. In step 810, based at least in part upon the geographical location of the security tag, the computer system will control one or more video cameras within the video camera system.

For example, if the security tag tracking system determines that a security tag has moved into an unauthorized zone, the security tag tracking system will control the video cameras in order to obtain video of the security tag while in the unauthorized zone. If a thief is holding the item to which security tag is attached, the video camera system will capture video of the thief. This video can be recorded and stored for later identification purposes. Additionally, the video can be used by security personnel in order to monitor the current system or direct someone to the location where the security tag is located.

Referring to FIG. 9, a flow diagram is shown illustrating a method of generating a control signal for a video camera for real-time tracking of an item in accordance with one embodiment. Similar to FIG. 8, the following flow diagram illustrates a process for controlling a video camera in order to capture video of a specific location that is associated with a security tag.

In step 900, a receiver system receives information about an item that is attached to a security tag. In step 902, the receiver system transmits location information to a computer system. In step 904, the computer system processes the location information to determine a geographical location of the item that is attached to the security tag. For example, the computer system determines where in a store the item is located. In step 906, the computer system generates a control signal for a video camera based at least partially on the geographical information of the item. In step 908, the computer system transmits the control signal to a video camera system. For example, instructions on the pan, tilt, and zoom of the camera are sent to the video system to allow a camera to follow a moving tag in real time. This allows for video surveillance of the store to be integrally utilized in connection with the security tag tracking system.

Referring to FIG. 10, a block diagram is shown of a security tag. The security tag includes circuitry 1000, an antenna 1002, and a battery 1004.

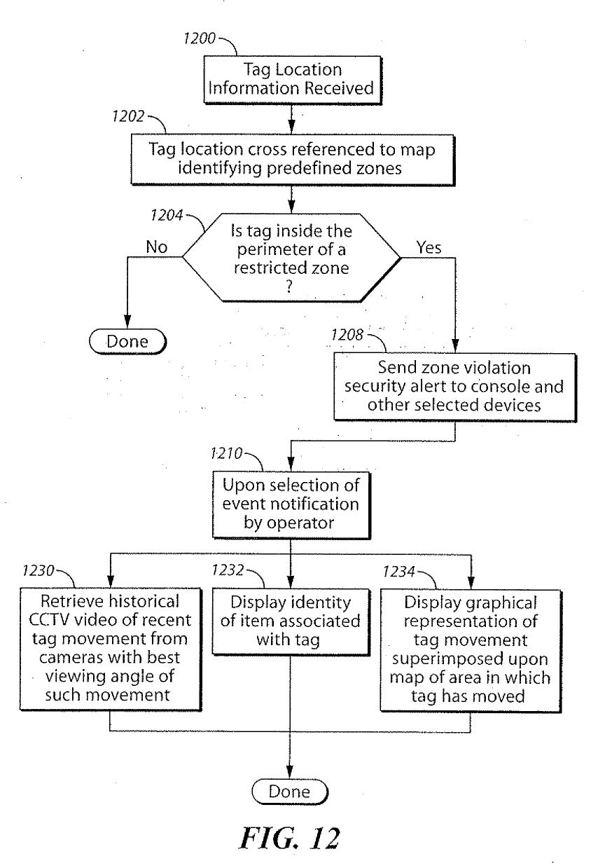

The circuitry 1000 is coupled with the antenna 1002 and the battery 1004. The circuitry 1000 draws power from the battery 1004 and sends information about the security tag through the antenna 1002. Various types of security tags can be utilized in accordance with the embodiments described herein. One example of a security tag is an UWB tag. Any type of radio emitting device that can be used to provide specific location information with a precise enough accuracy for use within a store can be used for some of the various embodiments described herein. Currently, UWB is the most accurate of the potential emitting devices. The accuracy of UWB is very useful to the security application described herein since the identification of individuals in a retail environment is the goal. UWB is more accurate than other radio signals because the UWB signal can be triangulated upon by azimuth and elevation Angle of Arrival (AOA) of signal and the Time Difference of Arrival (TDOA) to determine the location of the security tag UWB signal. Other radio systems such as carrier based systems including WiFi and RFID cannot be triangulated upon by azimuth and elevation Angle of Arrival (AOA) of signal and the Time Difference of Arrival (TDOA) to determine the location of the signal. Such other radio systems typically measure signal strength as the means to triangulate upon the location of the signal. For a variety of reasons, measuring signal strength to triangulate upon the location of a tag may not be accurate enough to be used with security tag tracking system described herein. For example, an inaccurate tracking system will fail to trigger proper alerts for zone violations as described in reference to FIG. 12 or may trigger false positive zone violation alerts. Also a less accurate tracking will not properly be able to select the appropriate video feed to follow a tag as it traverses multiple camera views or retrieve archived footage from multiple cameras. If another system emerges or a current system is modified to have localization capability accurate enough to prevent, for example, false triggers or false positive zone violations, such a system could be used with the embodiments described herein. However, some of the embodiments, such as tag removal detection can be presently used with technology other than UWB.

As discussed above, the security tag, in some embodiments, is able to detect removal from an item of merchandise. For example, the security tag can transmit a small electrical charge the item of merchandise through direct contact with the item, which creates a circuit. When the security tag is removed from the item the charge is no longer sent to the item, the circuit is broken and the security tag is able to detect the change in voltage, thereby detecting removal.

In another embodiment, the security tag includes a fastener that connects an item of merchandise to the security tag. When the security tag is connected to the item, an electrical circuit is completed. When the fastener is removed from the security tag, the circuit is broken and the security tag is able to detect a change in voltage, thereby detecting removal.

In yet another embodiment, the security tag includes an optical sensor that is sensitive to light. The security device is affixed to the item of merchandise in such a way that the optical sensor is covered and shielded from light. When the tag is removed from the item, the optical sensor is exposed to light. This causes the sensor to send a signal to the tag informing the tag of removal.

In still another embodiment, the security tag includes one or more wires that strap the tag to an item of merchandise. Generally, the tag is attached to the merchandise with the wire or wires in such a fashion that it cannot be detached from the item without first removing the wire or wires. The wires serve the dual purpose of securing the tag to the item and also creating an electrical circuit. If one of the wires is cut or broken the circuit is disrupted and the tag is able to detect the disruption of the circuit, thereby detecting tag removal or an attempt at tag removal.

In still another embodiment, the security tag includes a pin that fastens the tag to the merchandise and simultaneously completes an electrical circuit. Generally, the tag is attached to the merchandise with the pin in such a fashion that it cannot be detached from the item without first removing the pin. If the pin is removed from the tag the circuit is disrupted and the tag is able to detect the disruption of the circuit, thereby detecting tag removal or an attempt at tag removal.

The following FIGS. 11-21 demonstrate various rules that can be implemented by a security tag tracking system in accordance with different embodiments. The security tag tracking system can implement one or more of these rules in order to try and prevent theft from a store. It should be understood that these rules are exemplary and additional rules can also be implemented in order to prevent theft in other embodiments.

Referring to FIG. 11, a flow diagram is shown illustrating a method of detecting a theft at a point-of-sale terminal in accordance with one embodiment.

In step 1100, the system detects that a tag has been removed from an item. In step 1102, the system determines which item is associated with the tag that has been removed. For example, the system can query a database or a cross reference table to see which item is associated with the tag that has been removed. Next, in step 1104, the system will query a point of sale database and, in step 1106, determine if the item has been properly entered into the point of sale system prior to the tag being removed or sometime thereafter. Different systems will determine the appropriate amount of time from between when a tag is removed from and item how long to wait before sending a security alert that the item has not been properly entered into the point of sale system. For example, some systems will require the item to be scanned immediately thereafter (e.g., between 0 and 5 seconds), while other systems may be set up to allow more time to elapse (e.g., between 0 and 60 seconds). What is an appropriate time in one system may be unworkable in other systems.

If the system determines that the item was properly entered into the point of sale system, the system will disassociate the tag from the sold item in step 1112 and the process terminates. If the system determines that the item was not properly entered into the point of sale system, the system will send an alert to security personnel in step 1108. The security alert can be sent to a graphical user interface, such as shown in FIG. 2, or to a wireless device, such as described above with reference to FIG. 5. In step 1110, security personnel can select the event notification in order to have the system execute one or more of steps 1130, 1132 and 1134. One example of the event notification is shown in FIG. 2 in the system alert log 218. Alternatively, steps 1130, 1132 and 1134 can automatically be executed by the system upon detection of an event without having security personnel have to select the event notification from the graphical user interface.

In step 1130, the system retrieves the historical video that is available from the video camera system (e.g., a closed circuit television (CCTV) system) with the best viewing angle of the location of the tag that is associated with triggering the security alert. In FIG. 2, the video is shown as the video image 220. In step 1132, the system will display a representation of the item that was associated with the security tag. In FIG. 2, the representation of the item is shown as the item of merchandise 202. In step 1134, a representation of the recent security tag movement will be superimposed upon a representative map of the store. In FIG. 2, the tag movement will be shown as the security tag tracking path 216.

Referring next to FIG. 12, a flow diagram is shown illustrating a method of detecting a zone violation in accordance with one embodiment. In step 1200, location information about a tag is received by the system. In step 1202, the location information is used to determine a geographical location of an item associated with a security tag, the geographical location will correspond to a predefined zone within a store. For example, the location could correspond to one of the security zones shown in FIG. 2. Next, in step 1204, the system determines if the security tag is located inside of a restricted zone. If not, the process ends. If the security tag is located within a restricted zone, in step 1208, an alert message will be sent to a graphical user interface, such as shown in FIG. 2, or to a wireless device, such as described above with reference to FIG. 5. Thereafter, steps 1210, 1230, 1232 and 1234 proceed in the same manner to steps 1110, 1130, 1132 and 1134 of FIG. 11.

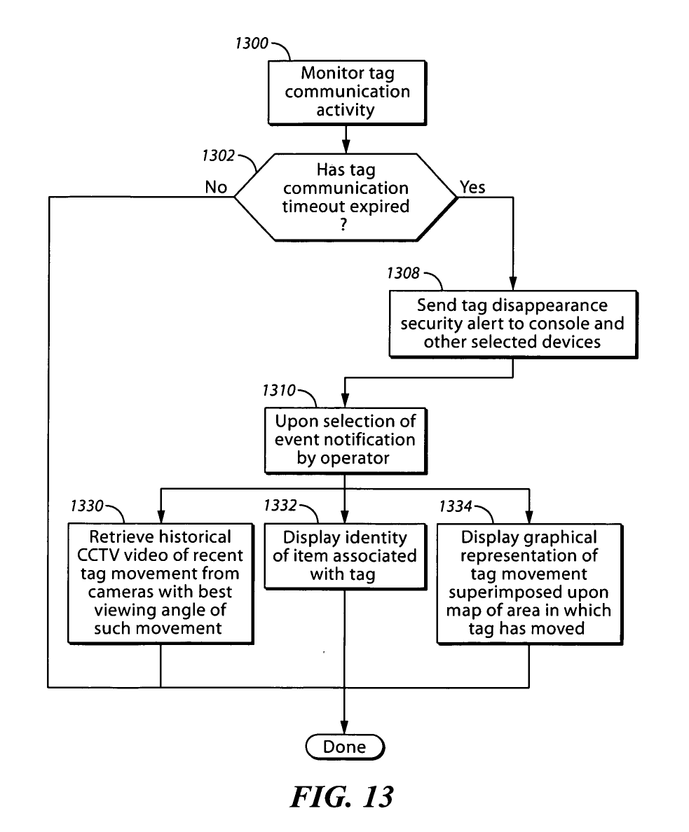

Referring to FIG. 13, a flow diagram is shown illustrating a method of detecting tag disappearance in accordance with one embodiment. In step 1300, the system monitors the communication activity of one or more security tags. In step 1302, the system determines if a tag communication timeout has expired. For example, if a tag is required to send a signal at least once every second, after a second of non-receipt of a signal, the timeout will have expired. Each system can have a different amount of time associated with a tag communication timeout period. For example, some systems may require communication a least once during a period from 0 to 1 second. Other systems may only require a communication at least once during 10 second period. Other timeout periods are also possible and will be used in different systems.

If the communication timeout period has not expired, the process ends. If the timeout period has expired, in step 1308, an alert message will be sent to a graphical user interface, such as shown in FIG. 2, or to a wireless device, such as described above with reference to FIG. 5. Thereafter, steps 1310, 1330, 1332 and 1334 proceed in the same manner to steps 1110, 1130, 1132 and 1134 of FIG. 11.

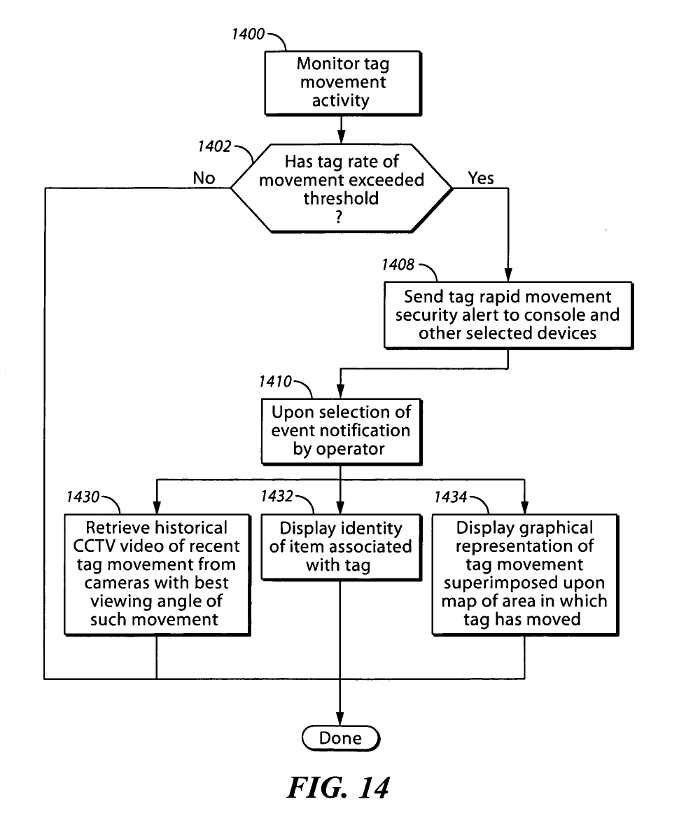

Referring to FIG. 14, a flow diagram is shown illustrating a method of detecting rapid movement of a tag in accordance with one embodiment. In step 1400, the system will monitor a security tag's movement activity. This can be done, for example, by calculating the distance a tag's previous location and a tag's current location. In step 1402, the system determines if a rate of movement of the tag has exceeded an allowed maximum for the system. The system can either calculate this by determining a rate of movement or can simply calculate a maximum distance between two location points for the security tag. A rapidly moving tag can indicate that someone is attempting to leave the store in a rapid fashion with an item that has not had the security tag removed.

If the maximum rate of movement is not exceeded, the process ends. If the maximum rate of movement is exceeded, in step 1408, an alert message will be sent to a graphical user interface, such as shown in FIG. 2, or to a wireless device, such as described above with reference to FIG. 5. Thereafter, steps 1410, 1430, 1432 and 1434 proceed in the same manner to steps 1110, 1130, 1132 and 1134 of FIG. 11.

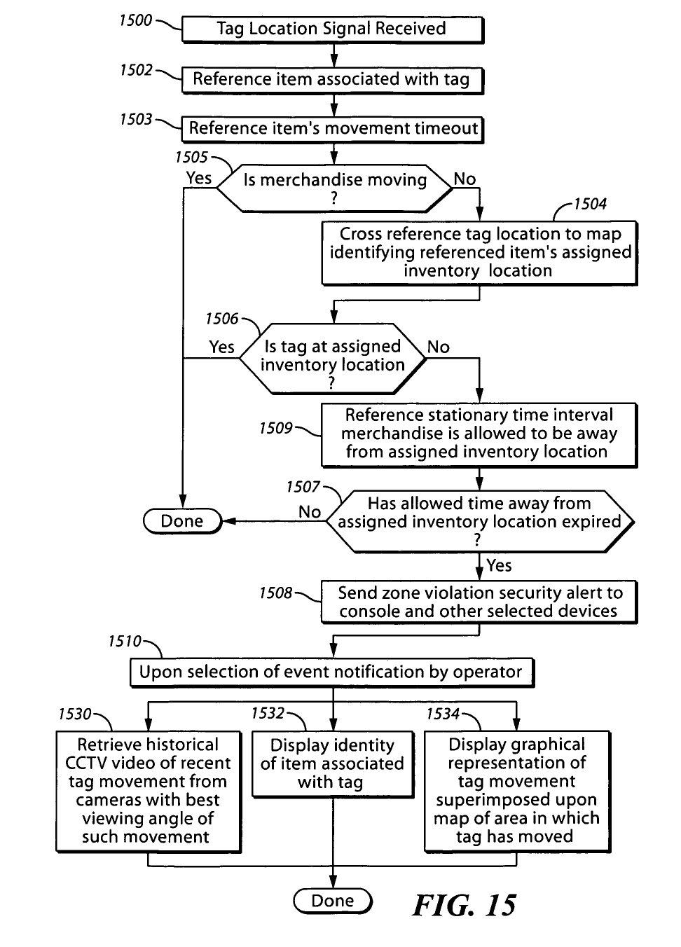

Referring to FIG. 15, a flow diagram is shown illustrating a method of detecting an inventory location timeout violation in accordance with one embodiment. In step 1500, location information for a security tag is received. In step 1502, the item associated with the tag is referenced, for example, in a database or cross reference list. Next in step 1504, the system cross references the tag location to a map identifying an assigned inventory location. Next in step 1506, the system determines if the security tag is assigned an inventory location. If the tag is not assigned an inventory location, the process ends. If the tag is assigned an inventory location the system determines what the stationary time interval the item of merchandise is allowed to be away from the assigned inventory location in step 1509. Next, in step 1507, the system determines if the tag has been away for the assigned inventory location for more than a maximum time away. A common method for an employee intent on theft is to cache items identified for theft in a “staging” location which can be, for example, in the back room or some other out-of-the-way location. It is conceivable that the location itself may not be a restricted zone and thereby not cause an alert merely by the zone. However, if the item has been too long away from its inventory location, then it can be retrieved and replaced for sale, thwarting the employee's designs. There is also a secondary benefit to the store in the case of a negligent customer not bothering to return an item to its inventory location (real time inventory location) when they have changed their minds about the purchase (merely placing it on a random shelf location) or with items left by the customer in the fitting room to name two examples.

If the maximum time away has not been exceeded, the process ends. If the maximum time away has been exceeded, in step 1508, an alert message will be sent to a graphical user interface, such as shown in FIG. 2, or to a wireless device, such as described above with reference to FIG. 5. Thereafter, steps 1510, 1530, 1532 and 1534 proceed in the same manner to steps 1110, 1130, 1132 and 1134 of FIG. 11.

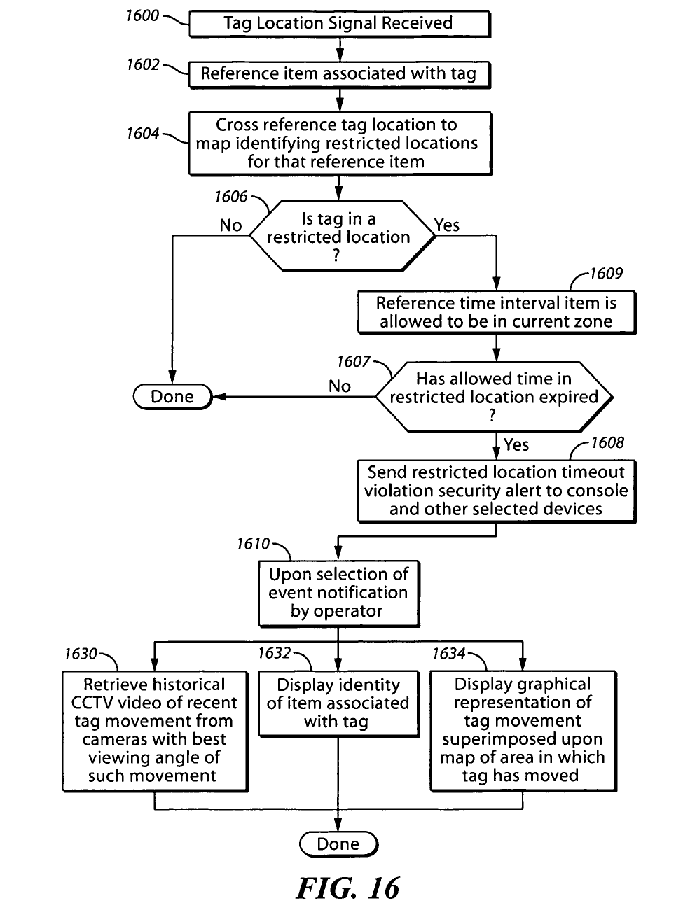

Referring to FIG. 16, a flow diagram is shown illustrating a method of detecting restricted location timeout violation in accordance with one embodiment. In step 1600, location information for a security tag is received. In step 1602, the item associated with the tag is referenced, for example, in a database or cross reference list. Next in step 1604, the system cross references the tag location to a map identifying restricted locations for the item.

In step 1606, the system determines if the security tag is in a restricted location. If not, the process ends. If the security tag is in a restricted location, the system determines the timer interval the item is allowed to be in the current zone.

Next, in step 1607, the security system determines if the maximum amount of time in a restricted location has expired. Some areas may have different timeouts other than the general “away from inventory location.” For example, some areas (such as the bathroom and the doorway) may cause an alert immediately, others, such as the fitting room, will allow more time before alert is signaled. This is important, for example, when combating organized criminals operating in gangs. One of the criminal could take an item and place it in a cart and take the cart to an isolated area of the store that does not have video coverage (although still on the store floor, this area could have a shorter timeout period before alert). If the merchandise is still there, an accomplice could come by and place the items in a foil lined bag. The system allows for providing security personnel with advance notice of possible ORC activity and the possibility of intervening before the actual theft takes place.

If the maximum amount of time in a restricted location has not been exceeded, the process ends. If the maximum amount of time in a restricted location has been exceeded, in step 1608, an alert message will be sent to a graphical user interface, such as shown in FIG. 2, or to a wireless device, such as described above with reference to FIG. 5. Thereafter, steps 1610, 1630, 1632 and 1634 proceed in the same manner to steps 1110, 1130, 1132 and 1134 of FIG. 11.

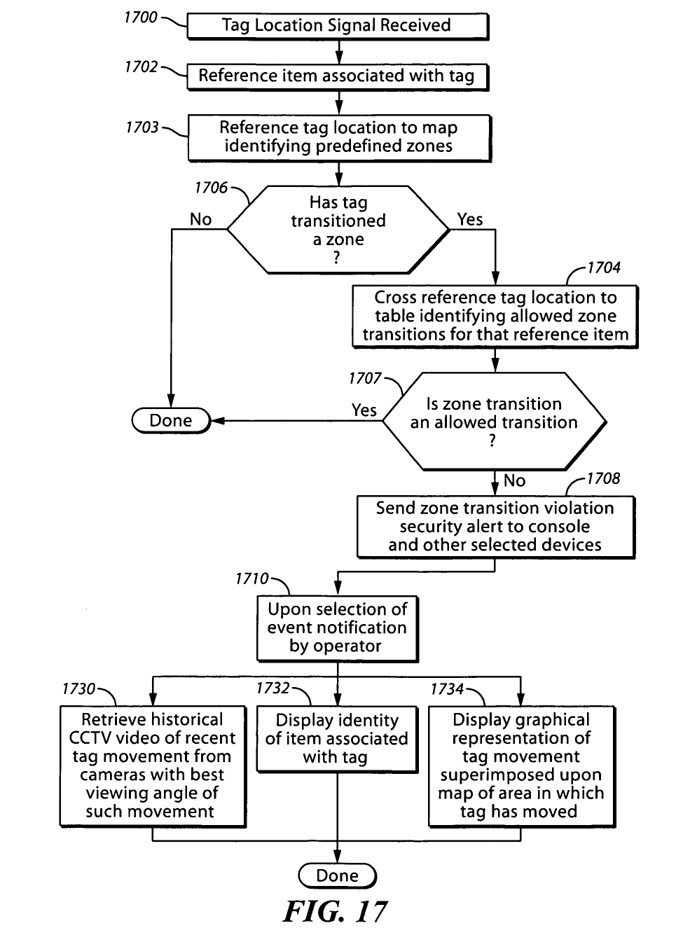

Referring to FIG. 17, a flow diagram is shown illustrating a method of detecting a zone transition violation in accordance with one embodiment. In step 1700, location information for a security tag is received. In step 1702, the item associated with the tag is referenced, for example, in a database or cross reference list. Next in step 1703, the system cross references the tag location to a table identifying allowed zone transitions for the item.

In step 1706, the system determines if the security tag has transitioned to a new zone. If not, the process ends. If the security tag has transitioned to a new zone, in step 1704, the system cross references the tag location to, for example, a table identifying the allowed zone transitions for the item.

Next, in step 1707, the security system determines if the zone transition was an allowed transition. In some instances, merchandise generally travels in a known direction, for example, from the store room to the retail floor to the cash register. In some cases, knowing that an item is traveling against the normal flow may be important to identifying employee or ORC theft attempts. For example, moving an item from the sales floor to a stocking staging area may indicate improper employee activity preparatory to theft.

If the zone transition is allowed, the process ends. If the zone transition is not allowed, in step 1708, an alert message will be sent to a graphical user interface, such as shown in FIG. 2, or to a wireless device, such as described above with reference to FIG. 5. Thereafter, steps 1710, 1730, 1732 and 1734 proceed in the same manner to steps 1110, 1130, 1132 and 1134 of FIG. 11.

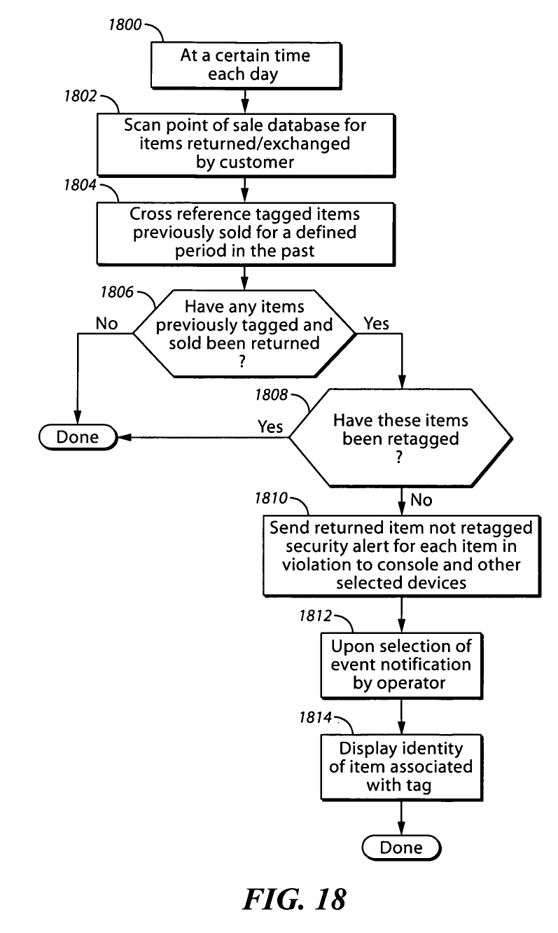

Referring to FIG. 18, a flow diagram is shown illustrating a method of detecting an item that has not been retagged in accordance with one embodiment. In steps 1800 and 1802, at a certain time (or times) during the day the system will scan the point-of-sale database for items that are returned or exchanged by customers. In step 1804, the system will cross reference tagged items that were previously sold for some defined period of time in the past. In step 1806, the system determines if any of the previously tagged items that were previously sold have been returned. If not, the process ends.

If any of the items that were previously sold have been returned, the system determines if the items have been retagged in step 1808. The method described in FIG. 3 is one method for tagging an item and registering it in the system. If the item has been retagged, the process ends. If the items have not been retagged, in step 1808, the system sends an alert message to a graphical user interface, such as shown in FIG. 2, or to a wireless device, such as described above with reference to FIG. 5. Thereafter, steps 1812 and 1814 proceed in the same manner to steps 1110 and 1132 of FIG. 11. by referencing a three dimensional model of the store with the three dimensional location of the tag.

In step 2006, if a selected event is occurring in real time, a live video feed from the selected camera will be displayed. If a historic event is selected, archived footage from the selected camera will be displayed using the method discussed in reference to FIG. 21.

In step 2008, if an operator wishes to view footage of tag locations prior to the event currently being watched, the operator can select the retrieval of such footage by selecting a graphical representation of “<<” button or some other input. Such footage will be retrieved and displayed according to the method discussed in reference to FIG. 21.

In step 2010, an operator can scan backwards and forwards within the current displayed footage by using a video slider. If real time footage is being displayed the operator can slide backwards and access footage of the security tag recently recorded to DVR or other database as footage is continually recorded in real time. This works in similar manner to a TiVo.

In step 2012, if an operator wishes to view footage of tag locations after the footage currently being watched, the operator can select the retrieval of such footage by selecting a graphical representation of “>>” button or some other input. Such footage will be retrieved and displayed according to the method discussed in reference to FIG. 21.

Referring now to FIG. 21, a flow diagram is shown illustrating a method of retrieving and concatenating video footage of historic movement and locations of a security tag from multiple cameras. The ability of the security tag tracking system to retrieve and concatenate archived video clips from multiple cameras at various times in the past creates an immediately accessible video history of the item in question (alerted item) that coincides with its movement history regardless of when the item was alerted, is a useful security feature. For example, it is conceivable that a store employee could take a tagged item to an area not monitored by a camera and remove the tag. The system will know that the tag has been removed and send an alert but will be unable to present video of the actual event due to the lack of camera coverage. In this instance, the system will construct a movement and video history of the tagged item such that whenever the tag crossed a video coverage zone, that video will be presented to security personnel in order

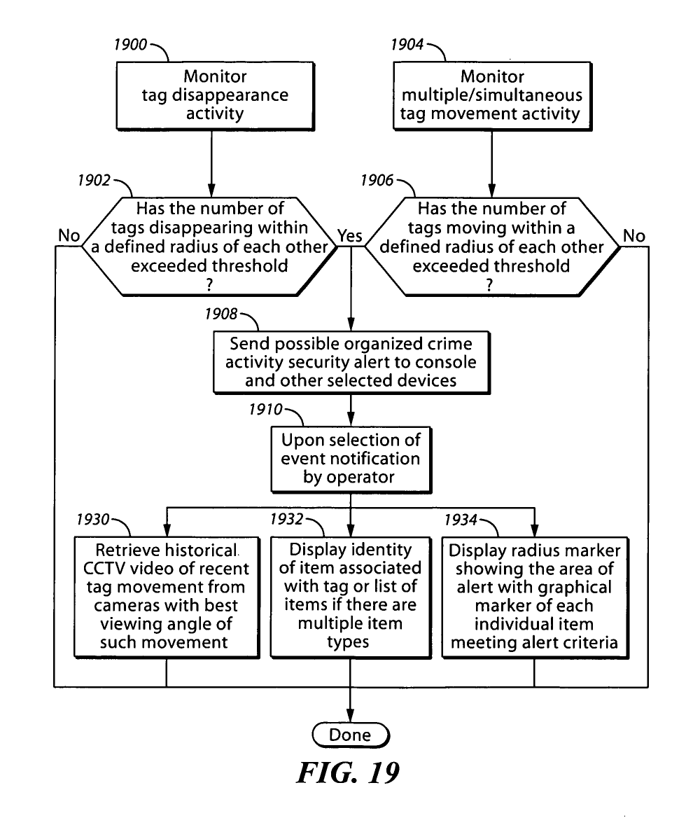

Referring to FIG. 19, a flow diagram is shown illustrating a method of detecting possible organized crime activity in accordance with one embodiment. In step 1900, the system monitors the security tags for disappearance activity. A security tag will disappear if, for example, it is place in a metal lined bag. These types of bags are commonly used by organized crime to steal merchandise from stores with traditional security systems. In step 1902, the system determines if the total number of tags within a defined area (e.g., within a certain radius) has exceeded a threshold amount. If not, the process ends. In step 1908, if the threshold amount has been exceeded—indicating organized crime activity—an alert message will be sent to a graphical user interface, such as shown in FIG. 2, or to a wireless device, such as described above with reference to FIG. 5. Thereafter, steps 1910 and 1930 proceed in the same manner to steps 1110 and 1130 of FIG. 11. In step 1932, the system displays the identity of an item associated with the tag or a list of items if there are multiple different types of items that disappeared. In step 1934, the system will also display an area or radius marker on the graphical map showing the area of alert in the store where the organized crime activity took place. Additionally, the system can show a graphical marker for the last known location of each of the items.

In reference to FIG. 20, a flow diagram is shown illustrating a method of selecting the camera with the best view of an event happening in real time or the historic movement of location of a security tag.

In step 2000, the computer references the location of a tag by retrieving tag location information from the security tag tracking system.

In step 2002, the tag location is referenced with a map of the store that corresponds with the best camera fields of view in the store. For example, a map of a store can be made that specifies that isle A is best viewed by camera B.

In step 2004, a camera is selected with best view of the area that the tag is located in. For example, using the example given in reference to step 2002, if the security tag is determined to be in isle A, that location is referenced with the best field of view of camera B so camera B will be selected. In an alternative embodiment, a camera is selected not by reference to a map with predetermined best areas of viewing but based on the nearest camera with a direct unobstructed view of the security tag, as determined to identify the likely perpetrator. Video concatenation capability can also be important in detecting and identifying possible Organized Retail Criminals. For example, organized criminals often place merchandise in foil lined bags (or some other foil lined item) that prevents electronics from communicating. From the system point of view, the tag will simply disappear. Tag disappearance is an event that can cause an alert in the system. However, if the tag disappears in an area not covered by video cameras, the location actual event (e.g., the location where the tag was last at before disappearance) cannot be displayed. Thus, concatenating prior video of the tagged item moving throughout the store will give security personnel important information as to the identity of the possible organized criminals currently in the store. There are other examples of instances when the prior video coverage of a tag's location would want to be retrieved, but will not be discussed herein.

In operation, in step 2100, a selection is made by an operator to reference video footage either prior to or after the event or currently displayed footage. Next, in step 2102, a database is referenced of the prior locations of the security tag. In step 2104, a best camera view is selected for each tag location for a previous span of time of predetermined length. For example, the best camera view can be selected for each tag location for the previous one minute, five minutes or other period of time depending on preference. The best camera view for each tag location is selected using the method described in reference to FIG. 20.

In step 2106, archived video is retrieved from each of the selected cameras of the time during which the security tag was best viewed by that camera. This is achievable in part because the video footage is archived with a time stamp indicating the time the footage was recorded. This time stamp is referenced when the security tag footage is retrieved. In an alternative embodiment, the any video footage from any camera in the system that had a view of the tag is retrieved.

If the more than one camera was selected in 2104 then step 2106 will result in multiple clips being retrieved. In step 2108, such clips or frames are concatenated in the sequential order of time in which each clip occurred.

In step 2110, the retrieved video footage is displayed. This may be video footage from a single camera or multiple cameras, and can be concatenated, sequential, or overlapping in time sequence. In step 2114, an operator is able to scan backwards and forward through the retrieved footage by use of a video slider.

In step 2112, if an operator wishes to review historical footage of tag locations prior to the locations displayed in the currently viewed footage the operator selects a graphical representation of a “<<” or some other input. The security tag tracking system will then retrieve prior footage using the previously discussed methods beginning with step 2100.

In step 2116, if an operator wishes to review historical footage of tag locations subsequent to the locations displayed in the currently viewed footage the operator selects a graphical representation of a “>>” or some other input. The security tag tracking system will then retrieve subsequent footage using the previously discussed methods beginning with step 2100.

Embodiments described herein with reference to FIGS. 1-21 may be implemented using one or more computers that include a central processing unit such as a microprocessor, and a number of other units interconnected, for example, via a system bus. Such a computer may also include, for example, a Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the computer to a communication network (e.g., a data processing network) and a display adapter for connecting the bus to a display device. The computer security tag tacking system shown in FIG. 1 can be implemented in this manner.

Furthermore, the various embodiments may be implemented on one or more of the following exemplary devices: a personal computer, a laptop, a tablet PC, a Personal Digital Assistant (PDA) or other electronic devices. In accordance with some embodiments, the various aspects described above may be implemented using computer programming or engineering techniques including computer software, firmware, hardware or any combination or subset thereof. Any resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network. In addition, one of ordinary skill in the art of computer science will be able to combine the software created as described with appropriate general purpose or special purpose computer hardware, Personal Digital Assistant (PDA) hardware, cellular telephone hardware or other electronic hardware to create a computer system or computer sub-system embodying the system and methods described herein.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A merchandise security system comprising:
a security tag configured to be attached to an item;
a receiver system configured to receive signals from the security tag and capable of generating location information for the security tag; and
a security tag tracking system coupled to the receiver system for receiving location information from the receiver system and determining a potential security related problem.

2. The system of claim 1 wherein the security tag tracking system determines a potential security related problem based upon the location information for the security tag.

3. The system of claim 1 further comprising a video camera system coupled to security tag tracking system.

4. The system of claim 3 wherein the security tag tracking system controls the video camera system based upon the location information for the security tag.

5. The system of claim 1 further comprising a point of sale terminal coupled to the security tag tracking system.

6. The system of claim 5 wherein the security tag tracking system determines a potential security related problem based upon information from the point of sale terminal.

7. The system of claim 1 wherein the security tag tracking system is configured to send information to a wireless electronic device upon determination that a potential security related problem exists.

8. The system of claim 1 further comprising a wireless electronic device capable of receiving alert information concerning a potential security related problem from the security tag tracking system.

9. The system of claim 1 wherein the security tag is an ultra wide band tag.

10. A merchandise security system comprising:
a security tag configured to be attached to an item;
a receiver system configured to receive an alert signal from the security tag upon removal of the security tag from the item; and
a security tag tracking system coupled to the receiver system for receiving alert information from the receiver system and determining a potential security related problem.

11. The system of claim 10 wherein the receiver system is configured to receive signals from the security tag and capable of generating location information for the security tag; and wherein the security tag tracking system coupled to the receiver system receives the location information from the receiver system.

12. The system of claim 11 further comprising a video camera system coupled to the security tag tracking system, wherein the security tag tracking system controls the video camera system based upon the location information for the security tag.

13. The system of claim 12 wherein the security tag tracking system controls the video camera system based upon determining of the potential security related problem based upon receiving the alert information indicating the security tag has been removed from the item.

14. The system of claim 10 wherein the security tag is an ultra wide band tag.

15. A security tag for aiding in the detection of theft, the device comprising:
circuitry;
a battery; and
an antenna,
wherein said circuitry and said antenna are powered by said battery, and wherein said circuitry comprises an instruction set to cause said antenna to transmit a signal when said security tag is attached to an article and later removed from said article.

16. The device of claim 15, further comprising electrodes for transmitting an electrical charge from said security tag into said article and electrodes for receiving an electrical charge from said article, wherein said instruction set is configured to cause said antenna to transmit a signal when said security tag transmits an electrical charge into said article, receives an electrical charge from said article, and later no longer receives an electrical charge from said article.

17. The device of claim 15, further comprising a removable fastener to couple said security tag to said article, wherein said fastener forms an electrical circuit when said security tag is coupled to said article, and wherein said instruction set is configured to cause said antenna to transmit a signal when said electrical circuit is broken.

18. The device of claim 15, further comprising an optical sensor, wherein said optical sensor is shielded from light when said security tag is attached to said article, and wherein said instruction set is configured to cause said antenna to transmit a signal when said optical sensor detects light.

19. The device of claim 15, further comprising a wire to attach said security tag to said article, wherein said wire forms an electrical circuit when said security tag is attached to said article, and wherein said instruction set is configured to cause said antenna to transmit a signal when said electrical circuit is broken.

20. The device of claim 15 wherein the security tag is an ultra wide band tag.
